(19) United States
(12) Patent Application Publication
(10) Pub. No.: US 2009/0084358 A1
(43) Pub. Date: Apr. 2, 2009

(54) FUEL INJECTOR MOUNTING SCHEME

(75) Inventor: Michael J. Zdroik, Metamora, MI (US)

Correspondence Address: DYKEMA GOSSETT PLLC, 39577 WOODWARD AVENUE, SUITE 300, BLOOMFIELD HILLS, MI, 48304-5086, US

(73) Assignee: Millennium Industries, Auburn Hills, MI (US)

(21) Appl. No.: 12/233,202

(22) Filed: Sep. 18, 2008

Related U.S. Application Data
(60) Provisional application No. 60/995,764, filed on Sep. 28, 2007.

(51) Int. Cl. F02M 69/46

(52) U.S. Cl. 123/470

(57) ABSTRACT

A fuel delivery system comprises a fuel rail having an inlet, an outlet opening, and a flow channel therein configured to allow fuel to be communicated between the inlet and outlet opening. The system further comprises a fuel injector having a body that includes a keying feature. The system still further comprises an injector cup configured for receiving a portion of the injector. The system yet still further comprises a mating feature associated with the fuel rail and/or the injector cup. The mating feature includes an aperture in the fuel rail and/or a portion of the injector cup, and is configured for receiving and mating with the keying feature. The mating feature is further configured to allow the injector to be rotated such that the keying feature can be transitioned from an aligned arrangement with the aperture of the mating feature to a misaligned arrangement to retain the injector.

### CROSS REFERENCE TO RELATED APPLICATIONS

This application claims the benefit of U.S. Provisional Application Ser. No. 60/995,764 entitled “Suspended Fuel Injector Mounting Scheme,” which was filed on Sep. 28, 2007, and which is hereby incorporated by reference in its entirety.

### FIELD OF THE INVENTION

The field of the present invention is fuel delivery systems. More particularly, the present invention relates to a mounting scheme for a fuel injector in fuel delivery systems, such as, for example, gasoline direct injection systems.

### BACKGROUND OF THE INVENTION

Fuel delivery systems for direct injection applications, such as, for example, fuel-injected engines used in various types of on-road and off-road vehicles, typically include one or more fuel rails having a plurality of fuel injectors associated therewith. In such applications, the fuel rails may include a plurality of outlet openings in which injector sockets or cups are affixed. Alternatively, the injector sockets or cups may be integrally formed with the fuel rail. In either instance, the fuel injectors are inserted into and coupled with the injector cups so as to allow for the fuel flowing in the fuel rail to be communicated to the fuel injectors. The fuel communicated from the fuel rail to the fuel injectors is then communicated to the combustion chamber of the engine. Accordingly, in these arrangements the fuel injectors are sandwiched between the fuel rail and a corresponding cylinder head of the engine.

One drawback of such direct injection systems is that these systems generate a relatively large amount of pressure (i.e., on the order of 10 MPa or more). As a result of this system pressure, a great amount of downward force is applied to the injector (i.e., on the order of 500 lbs.). This force causes the injector to want to “pop out” of the injector cup, especially if there is any misalignment of the injector resulting in an unequal distribution of the force about the injector. Accordingly, steps must be taken to ensure the retention of the injector within the cup that can withstand the applied force.

Prior attempts at retaining the injector in the cup have included the use of an external fuel injector retention clip. Such a clip is coupled with the injector and the outer portion of the fuel injector cup, and serves to hold and retain the injector in place by limiting both the axial and rotational movement of the injector relative to its longitudinal axis. While such an arrangement has generally been an adequate means for retaining the injector within the cup, it is not without its disadvantages. For instance, because the clips are external to the fuel injector cup, such clips may have a tendency to open due to the overloading of the downward force on the clip if, for example, the injector is not in exact alignment, and/or if the clip has weakened due to an extended period of use.

Therefore, there is a need for a fuel delivery system that will minimize and/or eliminate one or more of the above-identified deficiencies.

### SUMMARY OF THE INVENTION

The present invention is directed to a fuel delivery system, the constituent components thereof, and a method of assembling the inventive system. More particularly, the inventive system comprises a fuel rail having an inlet, an outlet opening, and a flow channel therein configured to allow for fuel to be communicated between the inlet and the outlet opening.

The system further includes a fuel injector having a body wherein the body includes a keying feature associated therewith. The system still further includes a fuel injector cup associated with the outlet opening of the fuel rail and is configured for receiving a portion of the fuel injector.

The system still further includes a mating feature associated with the fuel rail and/or the fuel injector cup that comprises an aperture configured for receiving and mating with the keying feature of the fuel injector. The mating feature is further configured to allow the fuel injector to be rotated such that the keying feature can be transitioned from an aligned arrangement with the aperture of the mating feature to a misaligned arrangement to thereby retain the fuel injector within the fuel injector cup.

Further features and advantages of the present invention will become more apparent to those skilled in the art after a review of the invention as it is shown in the accompanying drawings and detailed description.

### BRIEF DESCRIPTION OF THE DRAWINGS

FIG. 1 is a perspective view of a fuel delivery system in accordance with the present invention.

FIG. 2 is a side cross-sectional view of an exemplary embodiment of the fuel delivery system of FIG. 1 taken along lines 2-2 of FIG. 1.

FIG. 3 is a cross-sectional plan view of the fuel delivery system of FIGS. 1 and 2 taken along lines 3-3 of FIG. 2.

FIG. 4 is a side cross-sectional view of an alternate exemplary embodiment of the fuel delivery system illustrated in FIG. 2.

FIG. 5 is a side cross-sectional view of an alternate exemplary embodiment of the fuel delivery systems illustrated in FIGS. 2 and 4.

FIG. 6 is a side cross-sectional view of an alternate exemplary embodiment of the fuel delivery systems illustrated in FIGS. 2, 4, and 5.

FIG. 7 is a flow diagram of an exemplary embodiment of a method of assembling the fuel delivery system illustrated in FIG. 1.

FIGS. 8 and 9 are diagrammatic views of various steps in the method illustrated in FIG. 7.

### DETAILED DESCRIPTION OF PREFERRED EMBODIMENTS

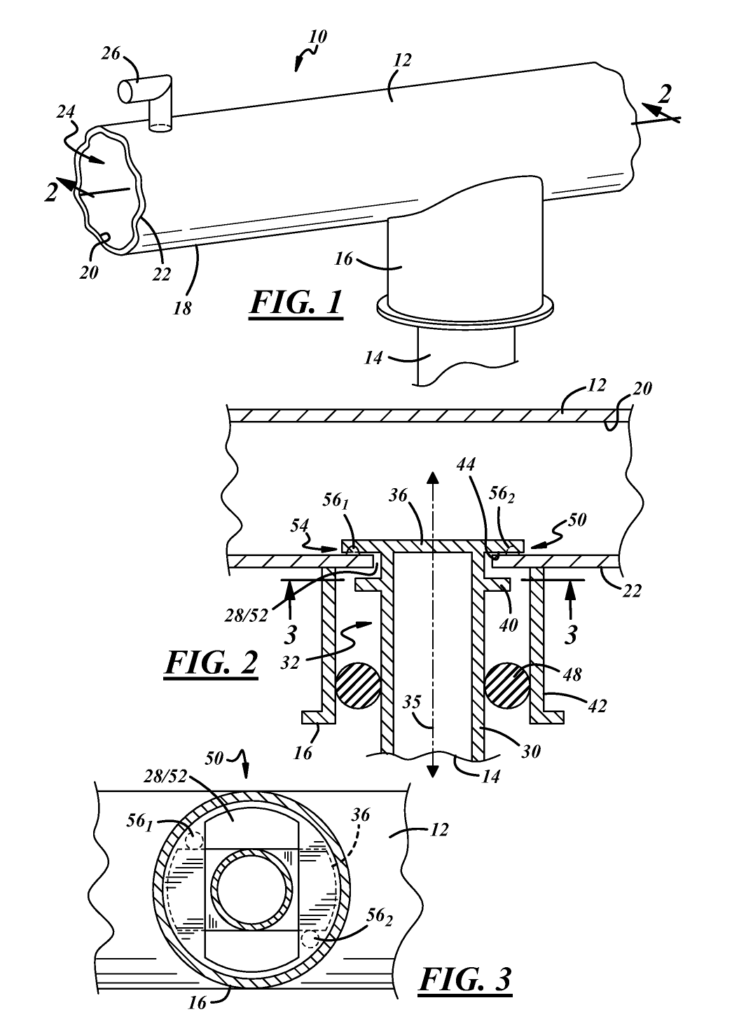

Referring now to the drawings wherein like reference numerals are used to identify identical components in the various views, FIG. 1 illustrates one exemplary embodiment of a fuel delivery system 10. Fuel delivery system 10 generally includes a fuel rail 12, a fuel injector 14, and a fuel injector cup 16.

With continued reference to FIGS. 1 and 2, fuel rail 12 will be described. Fuel rail 12 includes a hollow body 18 having an inner surface 20 and an outer surface 22. Hollow body 18 defines a flow channel 24 therein. Fuel rail 12 further comprises an inlet 26 in hollow body 18 in fluid communication with flow channel 24, and an outlet opening 28 in body 18. Inlet 26 is configured to be coupled to a fuel source or supply, such as, for example, the fuel tank of a vehicle, and flow channel 24 is configured to allow for the communication of fuel between inlet 26 and outlet opening 28. As will be described in greater detail below, outlet opening 28 is configured to communicate fuel in flow channel 24 to injector 14. Fuel rail 12 may be formed of any number of materials, such as, for example, metal (i.e., aluminum, stainless steel, etc.), thermoplastics, or a combination of the two.

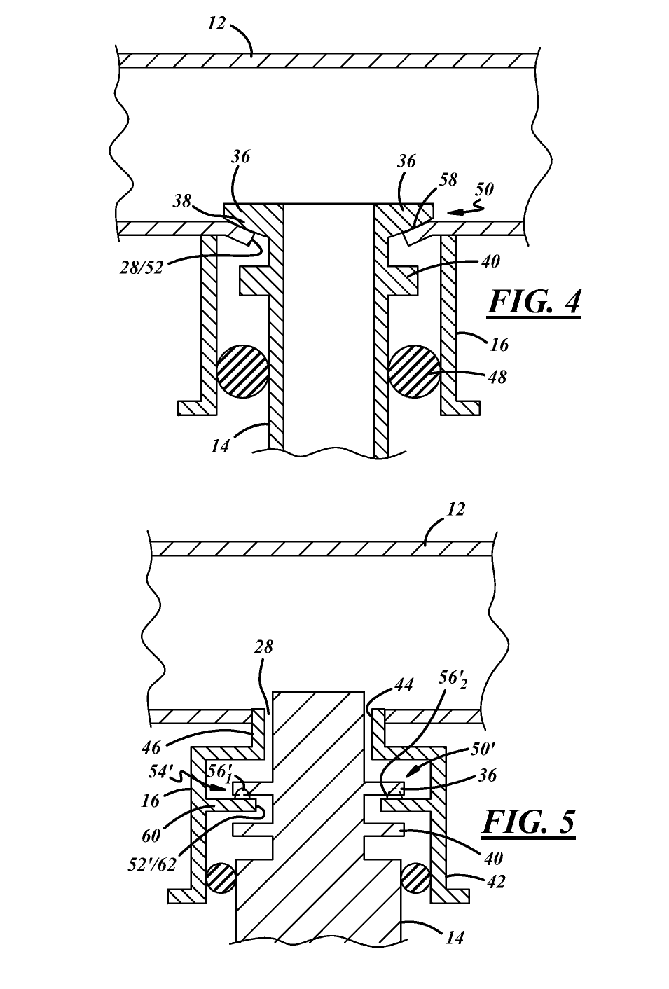

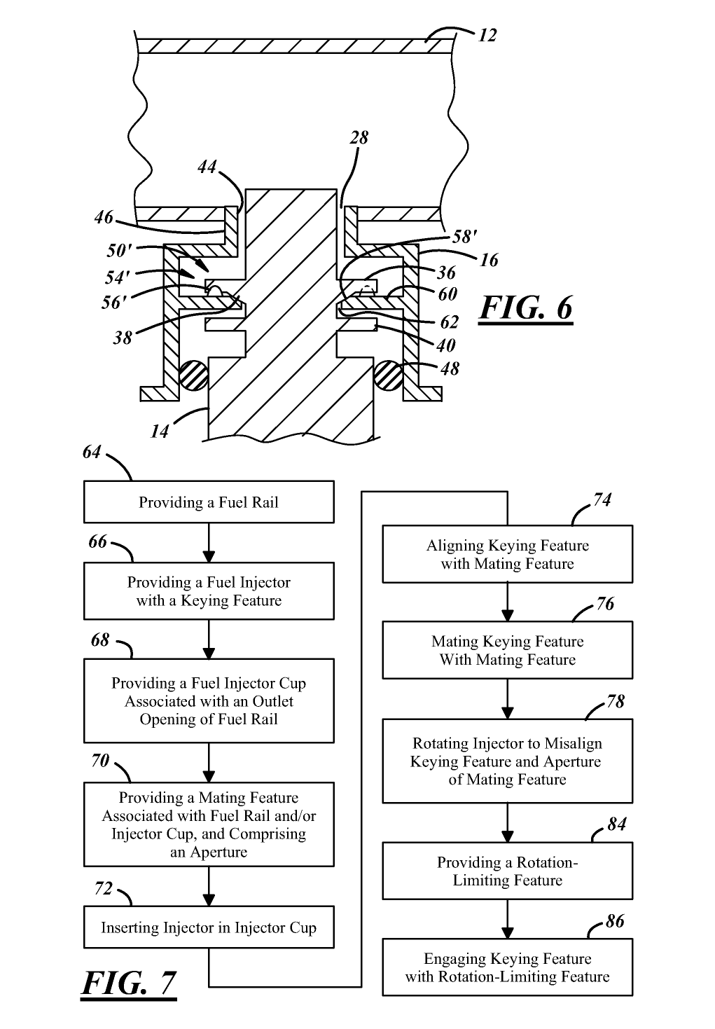

With continued reference to FIG. 2, fuel injector 14 and fuel injector cup 16 will be described. Fuel injector 14 includes a body 30 having a first end 32 and a second end 34. An inlet of the injector is disposed at first end 32, and an outlet at second end 34. Additionally, body 30 defines a longitudinal axis 35 extending through both first end 32 and second 34. Fuel injector 14 further includes a keying feature 36 associated with body 30. Keying feature 36 is disposed at or near first end 32 of body 30 proximate the inlet of fuel injector 14. Keying feature 36 is configured to be mated with a mating feature that, as will be described below, is associated with fuel rail 12 and/or fuel injector cup 16. In an exemplary embodiment, keying feature 36 comprises a key plate that is affixed to injector body 30 by, for example, welding, brazing, or any other similar process known in the art. In another exemplary embodiment, keying feature 36 is either machined onto or integrally formed with body 30. As will be described in greater detail below with respect to the embodiment of fuel delivery system 10 illustrated FIGS. 4 and 6, fuel injector 14, and keying feature 36, in particular, further includes a spherically-shaped portion 38.

In an exemplary embodiment, fuel injector 14 further includes a stop feature 40 associated with body 30. Stop feature 40 is disposed between keying feature 36 and the outlet of fuel injector 14, and is configured to substantially limit the axial movement of fuel injector 14 towards fuel rail 12 relative to the longitudinal axis of fuel injector 14 when fuel injector 14 is assembled with fuel injector cup 16 and fuel rail 12. In an exemplary embodiment, stop feature 40 comprises a stop plate that, as with keying feature 36, is affixed to injector body 30 by, for example, welding, brazing, or any other similar process known in the art. In an another exemplary embodiment, stop feature 40 is either machined onto or integrally formed with body 30.

With continued reference to FIG. 2, fuel injector cup 16 is associated with outlet opening 28 of fuel rail 12. Fuel injector cup 16 is configured to receive a portion of fuel injector 14 such that the inlet of fuel injector 14 is in fluid communication with outlet opening 28. Accordingly, fuel injector cup 16 includes a cup portion 42 and a passageway 44, wherein passageway 44 is configured to allow for the communication of fuel between fuel rail 12 and fuel injector 14. Fuel injector cup 16 may be associated with fuel rail 12, and outlet opening 28 thereof, in any number of ways known in the art. For example, as illustrated in FIG. 5, fuel injector cup 14 may include an inlet 46 that contains passageway 44 therein and that is configured to be inserted into outlet opening 28 and then affixed in place using known methods, such as, for example, welding and brazing processes. Alternatively, fuel injector cup 16 may be affixed to outer surface 22 of fuel rail 12 proximate outlet opening 28 such that passageway 44 is in alignment with outlet opening 28. In such an arrangement, fuel injector cup 16 may include a flange that is configured to be affixed to outer surface 22 of fuel rail 12. Still another alternative includes integrally forming fuel injector cup 16 with fuel rail 12 such that fuel rail 12 and fuel injector cup 16 are of unitary construction. In such an instance, outlet opening 28 and passageway 44 may be substantially one and the same. Accordingly, one of ordinary skill in the art will appreciate that fuel injector cup 16 may be associated with fuel rail 12 in any number of ways, all of which are within the spirit and scope of the present invention.

With continued reference to FIG. 2, in an exemplary embodiment fuel delivery system 10 further includes an O-ring 48 and a mating feature 50. In the illustrated embodiment, O-ring 48 is disposed between fuel injector body 30 and the inner surface of fuel injector cup 16, and cup portion 42 thereof, in particular. O-ring 48 is configured to provide a seal between fuel injector 14, fuel injector cup 16, and fuel rail 12 so as to eliminate, or at least substantially reduce, the amount of fuel and or vapor that may potentially leak from fuel delivery system 10.

Mating feature 50 is associated with fuel rail 12 and/or fuel injector cup 16 and comprises an aperture 52 in fuel rail 12 and/or a portion of fuel injector cup 16. Mounting feature 50, and aperture 52 thereof in particular, is configured to receive and mate with keying feature 36 when fuel injector 14 is assembled with fuel injector cup 16 and fuel rail 12. Accordingly, aperture 52 is sized and shaped to receive and mate with keying feature 36, which may take on any number of shapes and sizes, and therefore, both aperture 52 and keying feature are not limited to only arrangement in the illustrated embodiment. Mating feature 50 is further configured to allow fuel injector 14 to be rotated such that keying feature 36 can be transitioned from an aligned arrangement with aperture 52 to a misaligned arrangement, thereby retaining fuel injector 14 within fuel injector cup 16.

In an exemplary embodiment illustrated in FIG. 2, mating feature 50, and more particularly aperture 52, comprises outlet opening 28 of fuel rail 12. In such an embodiment, outlet opening 28 is sized and shaped to receive keying feature 36 such that keying feature 36 may be inserted through outlet opening 28. With reference to FIG. 3, and as will be described in greater detail below, once keying feature 36 is inserted through outlet opening 28, injector 14 may be rotated a predetermined amount until keying feature 36 is misaligned with outlet opening 28, thereby preventing fuel injector 14 from dropping downward. Accordingly, as illustrated in FIG. 2, a surface of keying feature 36 contacts or abuts inner surface 20 of fuel rail 12, which prevents fuel injector 14 from disengaging with fuel rail 12. In this embodiment, passageway 44 is also sized and shaped so as to allow keying feature 36 to pass therethrough and into outlet opening 28. In an exemplary embodiment, passageway 44 and outlet opening 28 have substantially the same size and shape.

With continued reference to FIG. 2, in an exemplary embodiment, fuel delivery system 10 further includes a rotation-limiting feature 54 configured to substantially limit the rotation of fuel injector 14 when keying feature 36 is mated with mating feature 50. In an exemplary embodiment, rotation-limiting feature 54 comprises at least one protrusion 56 disposed on inner surface 20 of fuel rail 12 proximate outlet opening 28. As illustrated in FIGS. 2 and 3, in an exemplary embodiment, rotation-limiting feature 54 includes two protrusions 56₁, 56₂ that are offset from each other and outlet opening 28 (aperture 52) such that once keying feature 36 is inserted through and rotated into misalignment with outlet opening 28, protrusions 56₁, 56₂ are located on opposite sides of keying feature 36 such that one protrusion limits rotation of fuel injector 14 in the clockwise direction, while the other protrusion limits rotation of fuel injector 14 in the counter-clockwise direction. It should be noted that a two-protrusion arrangement is provided for exemplary purposes only. In alternate embodiments, which remain within the spirit and scope of the invention, rotation-limiting feature 54 may include more or less protrusions to limit the rotation of fuel injector 14.

In yet another alternate embodiment, rotation-limiting feature 54 does not include any protrusions 56, but rather comprises, in part, a fuel injector retention clip that is configured to be coupled with both fuel injector 14 and fuel injector cup 16. When assembled, the combination of the fuel injector clip, fuel injector 14, and fuel injector cup 16 serve to limit the rotation of fuel injector 14. Accordingly, the present invention is not limited solely to the embodiments of rotation-limiting feature 54 described herein. Rather, those of ordinary skill in the art will recognize and appreciate that any number of rotation-limiting features known in the art could be implemented herein to limit the rotation of fuel injector 14.

Turning back now to mating feature 50, and with reference to FIG. 4, in an exemplary embodiment mating feature 50 includes a conical seat 58 proximate aperture 52. In this embodiment, conical seat 58 is formed either in inner surface 20 or the wall of fuel rail 12 proximate outlet opening 28, and/or in the bottom of fuel injector cup 16 proximate passageway 44. In one embodiment, conical seat 58 circumscribes outlet opening 28. Conical seat 58 is configured to receive spherically-shaped portion 38 of keying feature 36. Accordingly, once keying feature 36 is inserted through and rotated into misalignment with outlet opening 28, spherically-shaped portion 38 of keying feature 36 is seated within conical seat 58.

With reference to FIGS. 5 and 6, in alternate exemplary embodiment of mating feature 50, mating feature 50′ is illustrated. In this embodiment, mating feature 50′ comprises a washer 60 that is part of and disposed within fuel injector cup 16. Washer 60 includes a throughgoing orifice 62 that comprises aperture 52′ of mating feature 50′. Accordingly, orifice 62 is sized and shaped to receive keying feature 36 such that keying feature 36 may be inserted therethrough. In one exemplary embodiment, washer 60 is disposed in cup portion 42 of fuel injector cup 16. In another embodiment, however, washer 60 may be disposed within passageway 44. In either instance, washer 60 may be a separate and distinct component from cup portion 42 and passageway 44 that is positioned within fuel injector cup 16 and fixed in place using known affixation processes, such as, for example, welding or brazing processes. Alternatively, washer 60 may be integrally formed and of unitary construction with cup portion 42 or passageway 44.

As with the embodiment wherein mating feature 50′ is associated with fuel rail 12, once keying feature 36 is inserted through orifice 62 in washer 60, injector 14 may be rotated a predetermined amount until keying feature 36 is misaligned with orifice 62 (aperture 52′), thereby preventing fuel injector 14 from dropping downward. Accordingly, as illustrated in FIG. 5, a surface of keying feature 36 contacts or abuts a corresponding surface of washer 60 (i.e., the surface facing fuel rail 12), which prevents fuel injector 14 from disengaging with fuel injector cup 16.

As with the embodiment described above with respect to FIG. 2, and with continued reference to FIGS. 5 and 6, in an exemplary embodiment fuel delivery system 10 further includes a rotation-limiting feature 54′ configured to substantially limit the rotation of fuel injector 14 when keying feature 36 is mated with mating feature 50′. In an exemplary embodiment, rotation-limiting feature 54′ comprises at least one protrusion 56′ disposed on the surface of washer facing passageway 44, and therefore, fuel rail 12. In an exemplary embodiment, rotation-limiting feature 54′ includes two protrusions 56₁′, 56₂′ that are offset from each other and orifice 62 (aperture 52′) such that once keying feature 36 is inserted through and rotated into misalignment with orifice 62, protrusions 56₁′, 56₂′ are located on opposite sides of keying feature 36 such that one protrusion limits rotation of fuel injector 14 in the clockwise direction, while the other protrusion limits rotation of fuel injector 14 in the counter-clockwise direction. It should be noted that a two-protrusion arrangement is provided for exemplary purposes only. In alternate embodiments, which remain within the spirit and scope of the invention, rotation-limiting feature 54′ may include more or less protrusions to limit the rotation of fuel injector 14.

In yet another alternate embodiment, rotation-limiting feature 54′ does not include any protrusions 56, but rather comprises, in part, a fuel injector retention clip that is configured to be coupled with both fuel injector 14 and fuel injector cup 16. When assembled, the combination of the fuel injector clip, fuel injector 14, and fuel injector cup 16 serve to limit the rotation of fuel injector 14. Accordingly, the present invention is not limited solely to the embodiments of rotation-limiting feature 54′ described herein. Rather, those of ordinary skill in the art will recognize and appreciate that any number of rotation-limiting features known in the art could be implemented herein to limit the rotation of fuel injector 14.

With reference to FIG. 6, in an exemplary embodiment mating feature 50′ includes a conical seat 58′ proximate aperture 52′. In this embodiment, conical seat 58′ is formed in the surface of washer 60 that faces passageway 44, and therefore, fuel rail 12. In one embodiment, conical seat 58′ circumscribes orifice 62. Conical seat 58′ is configured to receive spherically-shaped portion 38 of keying feature 36. Accordingly, once keying feature 36 is inserted through and rotated into misalignment with orifice 62 (aperture 52′), spherically-shaped portion 38 of keying feature 36 is seated within conical seat 58′.

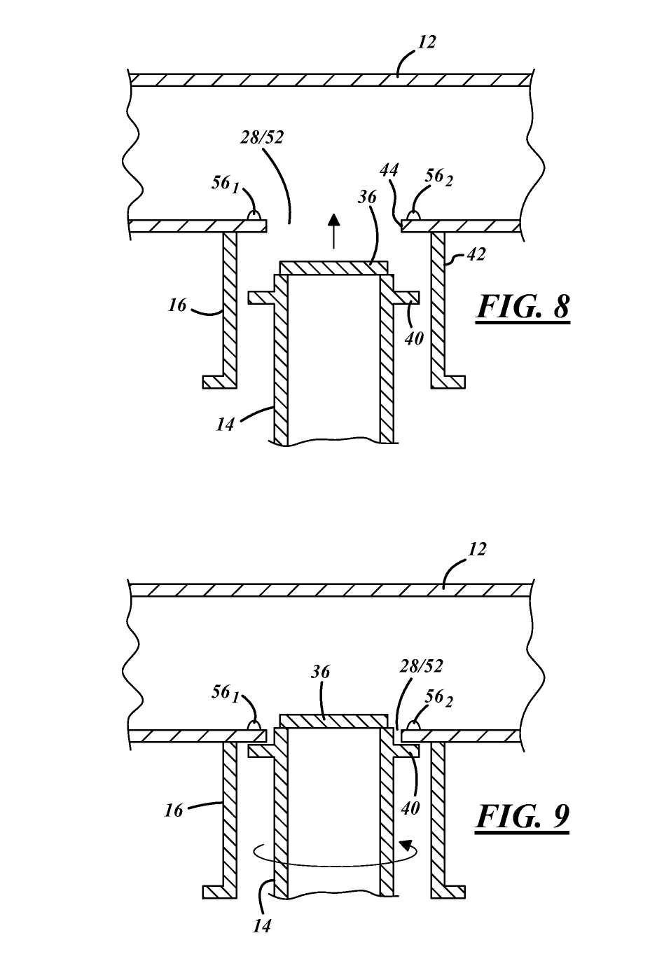

The foregoing having described exemplary embodiments of fuel system 10, an exemplary method of assembling fuel system 10 will now be described with reference to FIGS. 7-9. With particular reference to FIG. 7, in a first step 64, a fuel rail 12 having an outlet opening 28 is provided. In a second step 66, a fuel injector 14 having a body 30 and a keying feature 36 associated with body 30 is provided. In a third step 68, a fuel injector cup 16 associated with outlet opening 28 is provided. As described above, fuel injector cup 16 is configured for receiving a portion of fuel injector 14 and includes a passageway 44 therein configured to allow for the communication of fuel between fuel rail 12 and fuel injector 14. In a fourth step 70, a mating feature 50 associated with at least one of fuel rail 12 and fuel injector cup 16 and comprising an aperture 52 in one or both of fuel rail 12 and a portion of fuel injector cup 16 is provided.

With continued reference to FIGS. 7-9, and FIGS. 7 and 8, in particular, in a fifth step 72, fuel injector 14 is inserted into injector cup 16. In a sixth step 74, keying feature 36 is aligned with mating feature 50′, and in a seventh step 76, keying feature 36 is mated with mating feature 50. With particular reference to FIGS. 7 and 9, in an eighth step 78, once keying feature 36 is mated with mating feature 50, fuel injector 14 is rotated to create a misalignment between keying feature 36 and mating feature 50, and aperture 52 thereof, in particular (see FIG. 2).

In an exemplary embodiment wherein mating feature 50 comprises outlet opening 28 of fuel rail 12, mating step 76 includes a substep 80 of aligning keying feature 36 with outlet opening 28, and a substep 82 of inserting keying feature 36 through outlet opening 28. In an exemplary embodiment, aligning substep 80 includes aligning keying feature 36 with fuel injector cup passageway 44 and outlet opening 28, and inserting substep 82 includes inserting keying feature 36 through passageway 44 and outlet opening 28.

In an exemplary embodiment, providing a fuel injector step 66 includes providing a fuel injector 14 wherein keying feature 36 includes a spherically-shaped portion 38, and providing a mating feature step 70 includes providing a mating feature 50 including a conical seat 58. In this embodiment, mating step 76 includes seating spherically-shaped portion 38 into conical seat 58.

With continued reference to FIG. 7, the method further includes a ninth step 84 in which a rotation-limiting feature 54 is provided. In an exemplary embodiment, rotation-limiting feature 54 comprises at least one protrusion 56 on inner surface 20 of fuel rail 12 proximate outlet opening 28 is provided. In a tenth step 86, keying feature 36 is engaged with protrusion(s) 56 to limit the rotation of fuel injector 14.

In another exemplary embodiment, providing a mating feature step 70 further comprises providing a mating feature 50′ comprising a washer 60 disposed within fuel injector cup 16, wherein washer 60 includes an orifice 62 therein, and aperture 52′ comprises orifice 62. In this embodiment, mating step 76 comprises the substeps of aligning keying feature 36 with orifice 62, and inserting keying feature 36 through orifice 62. This embodiment further includes the ninth step 84 described above, which includes providing a rotation-limiting feature 54′. In this embodiment, however, rotation-limiting feature 54′ comprises at least one protrusion 56′ on the surface of washer 60 that faces fuel rail 12 proximate orifice 62. This embodiment further includes the tenth step 86 described above, namely, keying feature 36 engaging protrusion(s) 56′ to limit the rotation of fuel injector 14.

While the invention has been particularly shown and described with reference to the preferred embodiments thereof, it is well understood by those skilled in the art that various changes and modifications can be made in the invention without departing from the spirit and scope of the invention.

1. A fuel delivery system, comprising:
a fuel rail having an inlet, an outlet opening, and a flow channel therein configured to allow for fuel to be communicated between said inlet and said outlet opening;
a fuel injector having a body, said body including a keying feature associated therewith;
a fuel injector cup associated with said outlet opening, said fuel injector cup configured for receiving a portion of said fuel injector; and
a mating feature associated with at least one of said fuel rail and said fuel injector cup, said mating feature comprising an aperture configured for receiving and mating with said keying feature, said mating feature further configured to allow said fuel injector to be rotated such that said keying feature can be transitioned from an aligned arrangement with said aperture to a misaligned arrangement to thereby retain said fuel injector within said fuel injector cup.

2. The fuel delivery system in accordance with claim 1 wherein said aperture of said mating feature comprises said fuel rail outlet opening, said outlet opening having a size and a shape to allow said keying feature to be inserted therethrough.

3. The fuel delivery system in accordance with claim 2 wherein said fuel injector cup includes a passageway therein, said passageway having a size and shape to allow said keying feature to be inserted therethrough.

4. The fuel delivery system in accordance with claim 1 wherein:
said mating feature comprises a washer disposed within said fuel injector cup and said washer includes a throughgoing orifice therein;
said aperture of said mating feature comprising said orifice; and
said orifice having a size and a shape to allow said keying feature to be inserted therethrough.

5. The fuel delivery system in accordance with claim 1 wherein said fuel injector further includes a stop feature associated with said body configured to limit the axial movement of said fuel injector toward said fuel rail when said fuel injector is assembled with said fuel injector cup and said fuel rail.

6. The fuel delivery system in accordance with claim 1 wherein said keying feature includes a spherically-shaped portion and said mating feature includes a conical seat proximate said aperture, said conical seat configured to receive said spherically-shaped portion of said keying feature such that said spherical portion is seated in said conical seat.

7. The fuel delivery system in accordance with claim 1, further comprising a rotation-limiting feature configured to substantially limit the rotation of said fuel injector when said keying feature is mated with said mating feature.

8. The fuel delivery system in accordance with claim 7 wherein said mating feature comprises said outlet opening of said fuel rail and said rotation-limiting feature comprises at least one protrusion disposed on the inner surface of said fuel rail proximate said outlet opening.

9. The fuel delivery system in accordance with claim 7 wherein said rotation-limiting feature comprises a fuel injector retention clip.

10. The fuel delivery system in accordance with claim 7 wherein:
said mating feature comprises a washer disposed within said fuel injector cup, said washer including a throughgoing orifice therein;
said aperture of said mating feature comprising said orifice; and
said rotation-limiting feature comprises at least one protrusion disposed on a surface of said washer proximate said orifice therein.

11. A fuel injector, comprising:
a body having a first end and a second end;
an inlet disposed at said first end of said body;
an outlet disposed at said second end of said body; and
a keying feature associated with said body disposed proximate said inlet near said first end of said body, said keying feature configured to be mated with a mating feature associated with one of a fuel rail and a fuel injector cup.

12. A fuel injector in accordance with claim 11 wherein said keying feature includes a spherically-shaped portion.

13. A fuel injector in accordance with claim 11 wherein said fuel injector further includes a stop feature associated with said injector body disposed between said keying feature and said outlet.

14. A method of assembling a fuel delivery system, said method comprising the steps of:
providing a fuel rail having an outlet opening;
providing a fuel injector having a body and a keying feature associated with said body;
providing a fuel injector cup associated with said outlet opening, said fuel injector cup configured for receiving a portion of said fuel injector;
providing a mating feature associated with at least one of said fuel rail and said fuel injector cup, said mating feature comprising an aperture configured for receiving and mating with said keying feature;
inserting said fuel injector in said fuel injector cup;
aligning said keying feature with said aperture of said mating feature;
mating said keying feature with said mating feature; and
rotating said injector once said keying feature is mated with said mating feature to create a misalignment between said keying feature and said aperture.

15. The method of claim 14 wherein said aperture of said mating feature comprises said outlet opening of said fuel rail, said mating step comprising the substeps of aligning said keying feature with said outlet opening and inserting said keying feature through said outlet opening.

16. The method of claim 15 wherein said fuel injector cup includes a passageway therein and said aligning step further comprises aligning said keying feature with said passageway and said outlet opening, and said inserting said keying feature step comprises inserting said keying feature through said passageway and said outlet opening.

17. The method of claim 15 further including:
providing a rotation-limiting feature configured to limit the rotation of said fuel injector; and
engaging said fuel injector with said rotation-limiting feature.

18. The method of claim 14 wherein said mating feature comprises a washer disposed within said fuel rail cup, said washer including a throughgoing orifice therein and said aperture of said mating feature comprising said orifice, said mating step comprising the substeps of aligning said keying feature with said orifice and inserting said keying feature through said orifice.

19. The method of claim 18 further including:
providing a rotation-limiting feature comprising at least one protrusion on a surface of said washer proximate said orifice, and
engaging said keying feature with said at least one protrusion to limit the rotation of said fuel injector.

20. The method of claim 14 wherein:
said providing a fuel injector step includes providing a fuel injector wherein said keying feature includes a spherically-shaped portion;
said providing a mating feature step includes providing a mating feature including a conical seat; and
said mating step includes seating said spherically-shaped portion of said keying feature in said conical seat.

21. A fuel injector cup, comprising:
an inlet portion configured for coupling with a fuel rail, said inlet including a passageway therein configured to communicate fuel from said fuel rail to a corresponding fuel injector;
a cup portion configured to receive at least a portion of a fuel injector; and
a washer having a throughgoing orifice therein disposed within one of said cup portion and said passageway, said orifice configured to receive a keying feature of a fuel injector.

22. The fuel injector cup in accordance with claim 21 wherein said washer is affixed to one of said cup portion and said passageway.

23. The fuel injector cup in accordance with claim 21 wherein said washer is integrally formed with one of said cup portion and said passageway.

24. The fuel injector cup in accordance with claim 21 wherein said washer includes a conical seat formed therein disposed proximate said orifice.

25. A fuel rail, comprising:
a hollow body having an inner surface and an outer surface, said hollow body defining a flow channel therein;
an inlet in said hollow body in fluid communication with said flow channel;
an outlet opening in said body configured for communicating fuel from said flow passageway to a fuel injector; and
a conical seat formed in at least said inner surface of said hollow body proximate said outlet opening, said conical seat configured to receive a spherically-shaped portion of a fuel injector associated with said outlet opening.

26. The fuel rail in accordance with claim 25 wherein said conical seat circumscribes said outlet opening.
